(19) United States
(12) Patent Application Publication
(10) Pub. No.: US 2020/0205262 A1
(43) Pub. Date: Jun. 25, 2020

(54) CONVERSION CIRCUIT FOR A TUBULAR LED ARRANGEMENT OF A LAMP

(71) Applicant: SIGNIFY HOLDING B.V., EINDHOVEN (NL)

(72) Inventors: BERND ACKERMANN, AACHEN (DE); THEODORUS JOHANNES VAN DEN BIGGELAAR, VELDHOVEN (NL); PIETER JOHANNES STOBBELAAR, EINDHOVEN (NL); HAIMIN TAO, EINDHOVEN (NL); HENRICUS THEODORUS VAN DER ZANDEN, SINT-OEDENRODE (NL)

(21) Appl. No.: 16/620,954

(22) PCT Filed: Jun. 1, 2018
(86) PCT No.: PCT/EP2018/064418

§ 371 Date: Dec. 10, 2019

(30) Foreign Application Priority Data
Jun. 12, 2017 (EP) 17175490.6

(51) Int. Cl. H05B 45/37; F21K 9/278

(52) U.S. Cl. CPC H05B 45/37; F21Y 2103/10; F21K 9/278

(57) ABSTRACT

The invention provides a conversion circuit for a lamp. The conversion circuit converts first signals, from a ballast, into second signals, for a lighting arrangement. The conversion circuit comprises a transformer having characteristics which contribute to a desired conversion of the first signals to the second signals. The transformer, formed of a first winding and a second winding, further provides an isolated power supply for an auxiliary device connected to the second winding.

### FIELD OF THE INVENTION

This invention relates to conversion circuits for lamps, and in particular to conversion circuits comprising an inductor arrangement.

### BACKGROUND OF THE INVENTION

Solid state lighting (SSL) is rapidly becoming the norm in many lighting applications. This is because SSL elements such as light emitting diodes (LEDs) can exhibit superior lifetime and energy consumption, as well as enabling controllable light output color, intensity, beam spread and/or lighting direction.

Tubular lighting devices are widely used in commercial lighting applications, such as for office lighting, for retail environments, in corridors, in hotels, etc. A conventional tubular light fitting has a socket connector at each end for making mechanical and electrical connection to connection pins at each end of a tubular light. Conventional tubular lights are in the form of fluorescent light tubes. There is a huge installed base of light fittings equipped with electronic ballasts for fluorescent tube lamps. A lighting installation is considered to be the combination of an electronic ballast and a light emitting arrangement (e.g. lamp or lighting device) connected thereto.

There are now tubular LED (“TLED”) lamps which can be used as a direct replacement for traditional fluorescent light tubes. In this way, the advantages of solid state lighting can be obtained without the expense of changing existing light fittings. Indeed,

TLEDs that are compatible with fluorescent lamp ballasts are the most straightforward and lowest cost way of replacing fluorescent lighting by LED lighting. Both rewiring (removing the ballast, connecting a TLED directly to AC mains) and replacing the whole light fitting are considerably more cumbersome and expensive. Both electromagnetic (EM) and electronic high frequency (HF) ballasts are used in fluorescent lighting.

Typically, there is no mains isolation in ballasts or TLEDs connected thereto. Consequently, there will be live parts inside TLEDs connected to ballasts, the live parts being conductive parts which may cause an electric shock in normal use. Thus, all of the electronics inside the TLEDs must be treated as electrically unsafe high voltage electronics. It is not therefore possible to make a direct and electrically safe voltage connection to the electronics inside known TLEDs.

### SUMMARY OF THE INVENTION

The invention is defined by the claims.

According to examples in accordance with an aspect of the invention, there is provided a conversion circuit for converting first signals from a fluorescent ballast to second signals for a tubular LED arrangement of a lamp, the tubular LED arrangement being adapted to output light, the conversion circuit comprising: an input for receiving the first signals from the fluorescent ballast; an output for outputting the second signals to the tubular LED arrangement; an inductor arrangement connected between the input and the output, the inductor arrangement formed of a first winding and a second winding, wherein the second winding is magnetically coupled to the first winding, wherein the first and second windings together form a transformer for providing an isolated power supply for an auxiliary device of the lamp, and wherein at least one of a leakage inductance or a magnetizing inductance of the transformer contributes to a desired conversion of the first signals to the second signals.

The first and second windings together act as a transformer for an auxiliary device. In particular, the transformer enables an auxiliary device to be powered by the fluorescent ballast whilst remaining electrically/galvanically isolated. An auxiliary device may thereby be powered by an electrically safe connection to a conversion circuit for the lamp.

The first winding acts both as an inductor for the conversion circuit and as a part of the transformer for the auxiliary device. Thus, an inductor of a conversion circuit of the lamp may be appropriated for use in an isolated power supply for an auxiliary device. This reduces a size and complexity of a lamp containing the conversion circuit, as an existing inductor of a conversion circuit may be exploited to provide power to an auxiliary device. Moreover, a weight of the lamp may be significantly reduced, as the total number of windings in the lamp is reduced.

The conversion circuit may, for example, comprise or consist of a filter, an impedance matching circuit, a switched-mode power supply and so on. Generally speaking, any circuit of the lamp which comprises an inductor and converts signals using at least said inductor is considered to be a conversion circuit within the meaning of the present description.

The present invention relies on the usage of an existing inductor of a conversion circuit for a lamp as a winding for a transformer. The transformer provides power to an auxiliary device of the lamp. The auxiliary device may, for example, comprise a communications module for the lamp; a reserve battery for the lamp; a sensor; a lamp controller and so on.

The auxiliary device may thereby be located in an additional compartment outside the main body of the lamp. Thus, the space occupied by the lamp may be significantly reduced. This may be necessary, for example, to enable the lamp to ‘retrofit’ within an existing troffer, recess or light fitting.

In some embodiment, the conversion circuit is an impedance matching circuit, and at least one of a leakage or magnetizing inductance of the transformer formed from the first and second windings contributes to an impedance matching of the impedance matching circuit.

The leakage inductance of the transformer may act as a series inductance in the impedance matching circuit. The magnetizing inductance of the inductor forming the transformer may act as a parallel inductance in the impedance matching circuit. The transformer continues to provide isolation, from the high frequency ballast, to the auxiliary device.

In other embodiments, the conversion circuit is a switched-mode power supply, and the first winding forms an energy storage inductor of the switched-mode power supply.

The use of inductors in a switched-mode power supply, such as buck, boost or buck-boost converters, is well known to the skilled person. The present invention exploits the presence of such inductors to provide an isolated power supply for an auxiliary device of the lamp. Thus, an existing inductor is repurposed as a winding for a transformer.

Optionally, the conversion circuit comprises a capacitor arrangement connected between the input and the output. The capacitor arrangement may advantageously provide further filtering, impedance matching or energy storage capabilities to the conversion circuit.

In at least one embodiment, the conversion circuit is adapted such that the input comprises a two-terminal input for receiving first signals, the two-terminal input comprising a first input terminal and a second input terminal and the output comprises a two-terminal output for supplying the second signals, the two-terminal output comprising a first output terminal and a second output terminal.

Optionally, the inductor arrangement is connected between any one of: the first input terminal and the first output terminal; the second input terminal and the second output terminal; the first input terminal and the second input terminal; or the first output terminal and the second output terminal.

The inductor may be connected serially between the input and the output. In other embodiments, the inductor may be connected in a parallel arrangement between the input and the output. Connection of the inductor arrangement between the input and the output indicates that the inductor arrangement forms part of a path between any terminal of the input and any terminal of the output. For example, connecting an inductor arrangement between two input terminals provides a path from one input terminal to another input terminal, and thereafter to an output terminal.

In at least one embodiment, the second winding is galvanically isolated from both the input and the output.

Thus, when the conversion circuit is in use, the second winding may be galvanically isolated from both the ballast and the tubular LED arrangement. In this way, the auxiliary device may be advantageously galvanically isolated from both the ballast and the tubular LED arrangement, whilst also drawing power from the ballast. This allows the second winding and the auxiliary device to be isolated from electrically unsafe voltages (e.g. provided by the ballast) without restricting an operation of the tubular LED arrangement.

According to an aspect of the inventive concept, there is proposed a lamp comprising: the conversion circuit as previously described, and a tubular LED arrangement coupled to the output of the conversion circuit.

The lamp may further comprise an auxiliary device adapted to draw power from the second winding, wherein the auxiliary device is galvanically isolated from the conversion circuit.

As briefly indicated, the auxiliary device may comprise a communications module for the lamp; a reserve battery or energy storage device for the lamp; a sensor; a lamp controller and so on.

The auxiliary device may comprise an energy storage device, wherein a power provided by the second winding charges the energy storage device. In some embodiments, the energy storage device is adapted to provide an auxiliary power source to the tubular LED arrangement.

The tubular LED arrangement optionally comprises a rectifier, an LED driver and at least one LED arranged in a string.

The lamp may further comprise a filament emulation unit for connecting the input of the conversion circuit to the fluorescent ballast.

There is also provided a lighting installation comprising a fluorescent ballast; and a lamp as previously described.

According to another aspect of the inventive concept, there is also provided a method for converting first signals from a fluorescent ballast to second signals for a tubular LED arrangement of a lamp, the tubular LED arrangement being adapted to output light, the method comprising: receiving the first signals, from the fluorescent ballast, at an input; converting the first signals into second signals using at least an inductor arrangement connected between the input and an output, wherein the inductor arrangement is formed of a first winding and a second winding magnetically coupled to the first winding; outputting the second signals, to the tubular LED arrangement, at the output; and providing an isolated power supply for an auxiliary device of the lamp, wherein the first and second windings together form a transformer for providing the isolated power supply and at least one of a leakage inductance or a magnetizing inductance of the transformer contributes to a desired conversion of the first signals to the second signals.

### BRIEF DESCRIPTION OF THE DRAWINGS

Examples of the invention will now be described in detail with reference to the accompanying drawings, in which:

FIGS. 1 and 2 illustrate lighting installations according to known embodiments;

FIG. 3 illustrates a lamp comprising a conversion circuit according to a first embodiment;

FIG. 4 illustrates a transformer for the conversion circuit according to the first embodiment;

FIG. 5 illustrates a lamp comprising a conversion circuit according to a second embodiment;

FIG. 6 illustrates a transformer for the conversion circuit according to the second embodiment;

FIG. 7 illustrates a transformer for a conversion circuit according to another embodiment;

FIG. 8 illustrates a lighting installation comprising a conversion circuit according to a third embodiment;

FIG. 9 illustrates a lighting installation comprising a conversion circuit according to a fourth embodiment; and

FIG. 10 is a flow chart illustrating a method according to an embodiment.

### DETAILED DESCRIPTION OF THE EMBODIMENTS

The invention provides a conversion circuit for a lamp. The conversion circuit converts first signals, from a ballast, into second signals, for a lighting arrangement. The conversion circuit comprises a transformer having characteristics which contribute to a desired conversion of the first signals to the second signals. The transformer, formed of a first winding and a second winding, further provides an isolated power supply for an auxiliary device connected to the second winding.

According to a concept of the invention, there is proposed a conversion circuit having a first winding and a second winding magnetically coupled to the first winding. The transformer formed by the first and second windings is designed to have a magnetizing/leakage inductance which contributes to a conversion of first signals to second signals. The second winding provides an isolated power supply to an auxiliary device of a lamp. This allows the lamp to be minimized in size.

Embodiments are at least partly based on the realization that an inductor of a conversion circuit may be adapted to provide an isolated power source to an auxiliary device, and that transformer characteristics may be designed such that a leakage/magnetizing inductance of the transformer may contribute to a desired conversion of first signals. In particular, a leakage and/or magnetizing inductance of a transformer may supplant or act as an inductor arrangement of a conversion circuit through appropriate design of the transformer. Illustrative embodiments may, for example, be employed in retrofit lamps for connection to an existing (fluorescent) ballast. In particular, proposed embodiments enable a size of the lamp to be minimized, whilst providing an isolated power source to an auxiliary device (which allows further minimization of the lamp), whilst also providing suitable ballast compatibility.

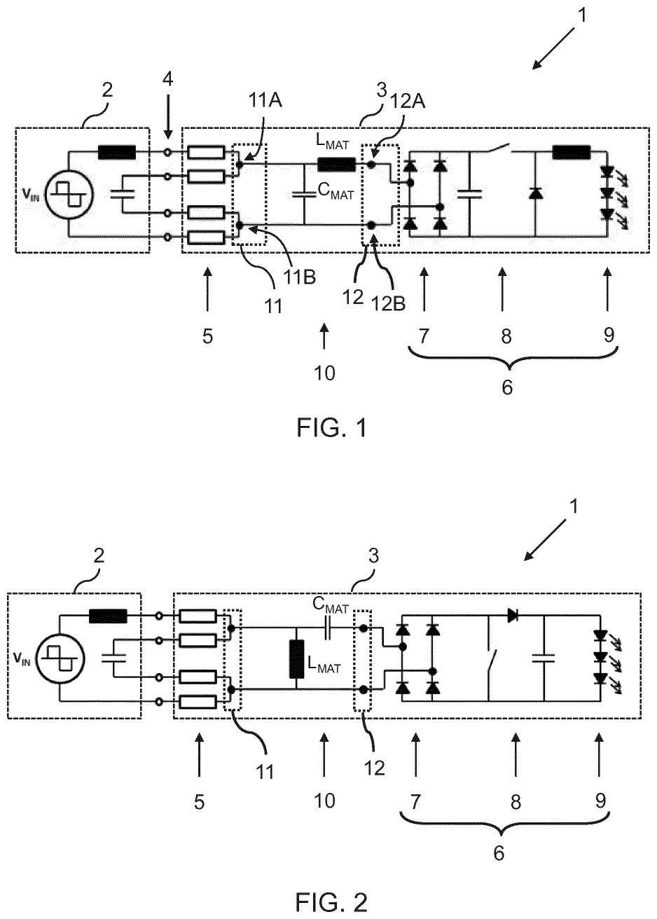

FIGS. 1 and 2 show block diagrams of different lighting installations 1, formed of a fluorescent ballast 2 and a lamp 3.

The ballast 2 comprises a half-bridge parallel resonant converter and it drives the electronic (high frequency, HF) ballast compatible lamp 3. The lamp comprises a filament emulation unit 5 and a tubular LED (TLED) arrangement 6. The tubular LED arrangement 6 comprises a rectifier 7, a LED driver 8 and at least one LED arranged in an LED string 9.

A conversion circuit 10 connects the filament emulation unit 5 to the tubular LED arrangement 6. In particular, the conversion circuit 10 comprises an input 11, connected to the filament emulation unit 5, and an output 12, connected to the tubular LED arrangement.

The input 11 comprises a first 11A and second 11B input terminal. The output 12 comprises a first 12A and second 12B output terminal.

The lamp 3 comprises four connection pins 4 that are used to connect it to the ballast 2. First and second pins are located at one end of the lamp and third and fourth pins are located at the other end of the lamp. The filament emulation unit 5 comprises first circuitry connecting the first and second pins to a first input terminal 11A of the conversion circuit and third and fourth pins to a second input terminal 11B of the conversion circuit.

The conversion circuit 10 converts first signals received from the ballast 2 (via the filament emulation unit 5) to second signals for the tubular LED arrangement 6. In some embodiments, the filament emulation unit 5 is omitted, such that the conversion circuit 10 may receive signals directly from the ballast 2. In such embodiments, the conversion circuit may be connected to the ballast via only two terminals.

The LED driver 8 of FIG. 1 is a buck converter, the LED driver 8 of FIG. 2 is a shunt switch.

It will be appreciated that, for most of these building blocks, the implementations shown in FIGS. 1 and 2 are just examples and other implementations of their functions are possible and are also used.

In the illustrated examples, the conversion circuit 10 consists of a matching circuit. Matching circuits 10 of HF ballast compatible lamps are used to reduce the output power of the ballast. In particular, a matching circuit of the lamp 3 appropriately matches an optimal impedance for the HF ballast 2.

In FIG. 1, the matching circuit 10 comprises an inductor L_{MAT} connected in series between the input 11 and the output 12 and a capacitor C_{MAT} connected in parallel between the input 11 and the output 12. This is commonly labelled a parallel capacitance/series inductance matching circuit. For reasons of compatibility, and for such a matching circuit, the LED driver may comprise a buck converter.

In FIG. 2, the matching circuit 10 instead comprises a capacitor C_{MAT} connected in series between the input 11 and the output 12, and an inductor L_{MAT} connected in parallel between the input 11 and the output 12. This is commonly labelled a parallel inductance/series capacitance matching circuit. To ensure compatibility with this matching circuit, the LED driver 8 may instead comprise a shunt switch. However, the skilled person will appreciate that there is no fixed relation between the design of the matching circuit and the type of LED driver used.

Generally, a matching circuit 10 typically comprises an inductor arrangement connected either in series or in parallel between the input 11 and the output 12.

Series connected elements in a matching circuit hamper current flowing to the LED string. Parallel connected elements in a matching circuit allow current to flow from the HF ballast to the lamp without reaching the LED string. The presence of a matching circuit 10 in the lamp 3 converts the half-bridge parallel resonant converter of the ballast 2 into a higher order resonant converter.

In embodiments, the conversion circuit 10 may instead or further comprise a filter (e.g. for filtering noise), a switched-mode power supply (such as a buck, boost or buck-boost converter) and so on. Generally speaking, the conversion circuit 10 comprises at least one inductor of an inductor arrangement for converting first signals received from the ballast to second signals for the TLED arrangement of the lamp.

The converting of first signals to second signals may therefore comprise impedance matching, filtering, power converting, voltage/current regulation and so on.

Pin safety circuitry and start-up circuitry may also be located between input 11 and output 12.

Because lamps containing TLED arrangements are typically designed to replace existing tubular lamps (e.g. fluorescent tubes), the volume of a lamp containing a TLED arrangement may be limited. In particular, its outside dimensions shall be nearly the same as that of the TL lamp that it replaces. Moreover, a weight of lamp containing TLED arrangements may have a restricted weight. This may be for reasons of compatibility with existing light fittings. By way of example, the international standard IEC 62776 “Double-capped LED lamps designed to retrofit linear fluorescent lamps—Safety specifications”, Edition 1.0, 2014-12, states that “The entire mass of a lamp shall not exceed 200 g for a G5-capped lamp and 500 g for a G13-capped lamp.”

Due to these space and weight restrictions, it would be beneficial to locate an auxiliary device (e.g. containing batteries or circuitry for supported functions such as sensing, communication and/or control) in an additional compartment outside the lamp and connect it to the lamp using a cable.

Circuitry of an auxiliary device will normally be operable using electrically safe low voltage electronics. Electrically safe low voltages may be associated with an upper limit of 60 VDC or 42.4 VAC, in accordance with the UL 60950-1 standard. In order to decrease the chance of a dangerous electrical shock to a user, it is therefore desirable to establish an electrically safe low voltage connection between the lamp and the auxiliary compartment outside the lamp. This requires some electrically safe low-voltage electronics inside the lamp.

Commonly used ballasts do not comprise mains isolation. Consequently, there will be live parts inside a lamp connected to the TL ballast, which may cause an electric shock. Since typical lamps containing a TLED arrangement do not comprise mains isolation, all of the electronics inside such lamps must be considered electrically unsafe high voltage electronics. It is not therefore possible to make a direct electrically safe low voltage connection to the electronics inside currently used lamps.

Although mains isolation in a lamp could be achieved using a dedicated isolation transformer, this would significantly increase the weight of the lamp and also occupy a significant fraction of the limited space available.

The present invention proposes to appropriate an inductor of a conversion circuit 10 to provide power to an isolated auxiliary device of the lamp 3. In particular, an inductor of an inductor arrangement of the conversion circuit is treated as a first winding of a transformer. A second winding is magnetically coupled to the first winding so as to provide an isolated power supply to the auxiliary device.

Put another way, an inductor of a conversion circuit is replaced by a transformer. A leakage inductance of the transformer may act as a series inductance for the conversion circuit. A magnetizing inductance of the transformer may act as a parallel inductance for the conversion circuit. The transformer may be designed to have characteristics (i.e. leakage/magnetizing inductance) appropriate for providing the necessary inductance for the conversion circuit, thereby negating the need for an additional inductor.

It will be clear that voltage adaptation between the ballast 2 and the LED string 9 may be performed by the LED driver 8. In this way, the transformer need not be used for such voltage adaptation (as is typical for a transformer). Rather, the invention proposes using the transformer both (i) for galvanic isolation of an auxiliary device (and optionally the output) and (ii) as an inductance in the matching circuit. In this way, only a small amount of volume and/or weight is added to the lamp 3, assuming that an inductance would be required regardless (e.g. in a conversion circuit).

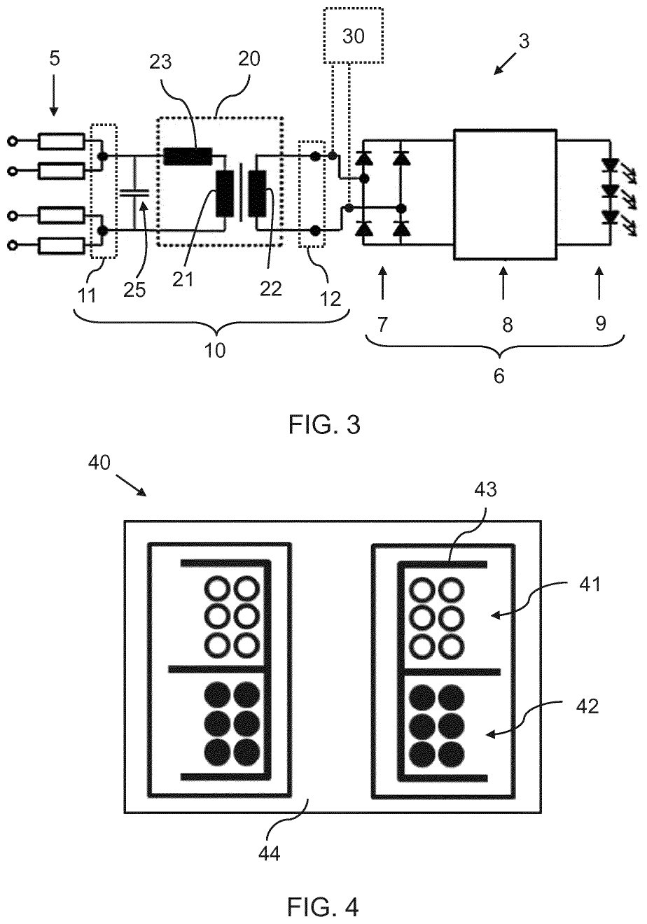

FIG. 3 illustrates a first embodiment of a conversion circuit 10, in the context of a lamp 3. The ballast has been omitted for the sake of clarity.

The conversion circuit 10 comprises an inductor arrangement 20 connected between the input 11 and the output 12 of the conversion circuit 10. Preferably, the conversion circuit 10 comprises only passive components.

The inductor arrangement comprises a first inductor 21 forming a first winding 21, and a second winding 22 magnetically coupled to the first winding. In this way, a current flowing in the first winding induces a corresponding current in the second winding 22. The first winding 21 and the second winding 22 together form a transformer. The first 21 and second 22 windings may alternatively be labelled primary/main and secondary/auxiliary windings respectively.

The transformer 21, 22 provides an isolated power supply for connection to an auxiliary device 30 of the lamp 3. In particular, the second winding 22 is galvanically isolated from the first winding 21 and thereby from the ballast. The auxiliary device 30 may be positioned to draw power from the second winding 22, so as to be galvanically isolated from the first winding 21 and consequently the ballast.

The first winding 21 contributes to the conversion of first signals received at the input 11 to second signals provided at the output 12 of the conversion circuit. That is, the transformer is designed to have characteristics which enable it to replace an inductor of an existing or known conversion circuit 10. In particular, a leakage inductance of a transformer acts as a series inductance in the matching circuit. This is represented by a leakage inductor 23 of FIG. 3. Thus, the circuit consisting of the leakage inductor 23 and the transformer 21, 22, as illustrated in FIG. 3, is considered to be an equivalent circuit to an actual (non-ideal) transformer 21, 22.

As is well known to the skilled person, an ideal transformer has a first winding 21 with Nₚ primary turns and a second winding 22 with Nₛ secondary turns. The relationship between the first and second windings, of such an ideal transformer, is governed by the well-known equation:

$$\frac{{V}_{p}}{{V}_{s}} = \frac{{N}_{p}}{{N}_{s}} \qquad ( 1 )$$

In equation (1), Vₚ represents a voltage applied to the first winding, and Vₛ represents a voltage applied to the second winding. As no energy is stored inside the ideal transformer, the power (instantaneous energy) flowing into the first winding 21 is equal to the power flowing out of the second winding 22. With the current Iₚ representing the current flowing into the first winding and the current Iₛ representing the current flowing into the second winding, this results in the following equations:

$$\begin{matrix}{V}_{p} \cdot {I}_{p} + {V}_{s} \cdot {I}_{s} = 0 & ( 2 ) \\ \frac{{I}_{p}}{{I}_{s}} = - \frac{{N}_{s}}{{N}_{p}} & ( 3 )\end{matrix}$$

However, such ideal transformers are rarely used in tubular lamps for voltage/current conversion, as such transformers are typically heavy, bulky and of a large volume or surface area. Indeed, as previously indicated, an LED driver 8 may be used to perform such conversion.

The transformer 21, 22 used for the conversion circuit of the present invention is intended to replace or act as an inductor for the conversion circuit, as well as provide galvanic isolation. In particular, the transformer is designed to have non-ideal characteristics (here a leakage inductance 23) to assist in converting the first signals at the input 11 to second signals at the output 12.

As the transformer need not contribute to a voltage conversion, the transformer may be lighter and of a smaller volume than typical transformers. Indeed, assuming that a conversion circuit requires an inductance to operate correctly/efficiently, only a small amount of volume and/or weight is added to the lamp 3 by using a transformer 21, 22 (and exploiting a leakage/magnetizing inductance) rather than an inductor alone.

In this way, the transformer 21, 22 acts as an inductor in the conversion circuit 10. For example, the transformer, and in particular the leakage inductance, may contribute to an impedance matching by the conversion circuit; a filtering by the conversion circuit (e.g. in an LC circuit or a PI filter); a power supply generation by the conversion circuit (e.g. an energy storage inductor of a buck-boost circuit) and so on.

The characteristics of the transformer 21, 22 are designed such that a leakage and/or magnetizing inductance from the transformer contributes to a desired conversion of signals received at the input 11 to signals provided at the output 12. Suitable transformers having such characteristics will be described later.

Preferably, the first winding and the second winding have a same number of turns, such that the voltage across the first winding 21 is the same as an induced voltage across the second winding 22. However, the number of windings may be varied so as to alter the inductance provided by the transformer 21, 22.

The auxiliary device 30 may, for example, comprise a lamp controller, an auxiliary power source, a sensor or a communications module for the lamp. As previously described, it may be advantageous to provide such an auxiliary device to provide additional functionality to the lamp, beyond that of simple illumination.

Put another way, the auxiliary device 30 may be positioned outside a casing of the lamp, but be adapted to provide some functionality to the lamp (in particular, functionality capable of operating at low voltages). This allows for a size of the lamp to be significantly reduced, for example, so as to fit within an existing troffer or void previously occupied by a different tubular lamp (e.g. a fluorescent lamp). This improves an ease of retrofitting LED-based lamps in existing light fittings or installations.

In order to provide suitable leakage inductance for carrying out the functions of the conversion circuit, the first 21 and second 22 windings may form an atypical or imperfect transformer. That is, the transformer 21, 22 may be specifically designed to provide a leakage inductance suitable for replacing an inductor of a known conversion circuit.

The conversion circuit may also comprise a capacitor arrangement 25 connected between the input 11 and the output 12. Here, the capacitor arrangement is connected in parallel between the input 11 and the output 12, but in other embodiments the capacitor arrangement 25 may be connected in series between the input 11 and the output 12.

It will be apparent that the inductor arrangement 20, comprising the transformer 21, 22, is connected between the input 11 and the output 12.

FIG. 4 illustrates a cross-section of a suitable transformer 40 for the first embodiment of the conversion circuit 10. In particular, the transformer ensures a leakage inductance (i.e. an effective leakage inductor 23) of a suitable and precise value can be provided. The transformer provides mains (i.e. ballast) isolation and a substantial leakage inductance.

The transformer 40 comprises a first winding 41 and a second winding 42. The first and second windings are arranged around a same central axis, with the first winding being disposed above (i.e. vertically offset from) the second winding. A radius or diameter of the first and second windings may be substantially the same. The windings are mounted on bobbin 43 which forms the shape of the coils. The transformer 40 further comprises a soft magnetic core 44 disposed between and surrounding the bobbin 43.

The leakage inductance of the transformer 40 can be controlled by the number of turns of the first and second windings and by the geometry of the windings, such as adjusting a distance between the first and second windings.

In particular, if a turns ratio (Nₚ/Nₛ) is fixed, then a leakage inductance will be proportional to the square of the number of turns (i.e. of either first/second winding or the summed number of turns of the first and second windings). Leakage inductance is increased for an increased distance between a first and second winding.

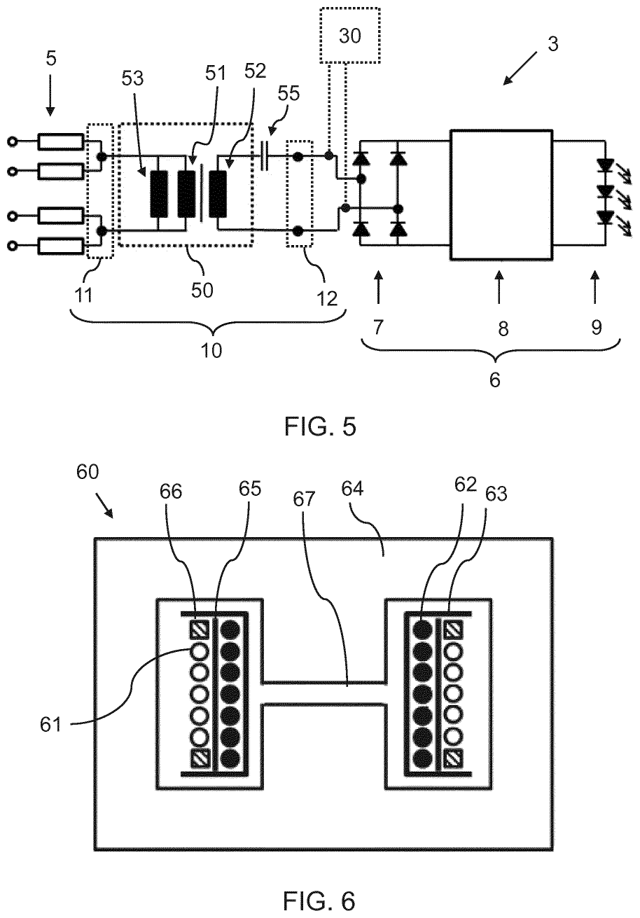

FIG. 5 illustrates a conversion circuit 10 according to a second embodiment of the invention. The conversion circuit 10 is described in the context of a lamp 3, as previously described. The second embodiment represents a modified version of the first embodiment, and elements common to both embodiments will not be repeated for the sake of brevity.

The conversion circuit 10 comprises an inductor arrangement 50 connected between the input 11 and the output 12. The inductor arrangement comprises an inductor 51, forming a first winding 51, and a second winding 52. The first 51 and second 52 windings together form a transformer 51, 52.

As before, the transformer 51, 52 provides an isolated power supply to an auxiliary device 30.

The transformer 51, 52 provides an inductance which contributes to a desired conversion of first signals received at the input 11 to second signals provided at the output 12 of the conversion circuit 10.

However, in the conversion circuit 10 according to the second embodiment, the transformer formed by the first 51 and second 52 windings provides a parallel inductance between the input 11 and the output 12. The parallel inductive is represented by a parallel inductor 53, which represents the magnetizing inductance of the transformer 51, 52. Thus, the circuit consisting of the parallel inductor 53 and the transformer 51, 52, as illustrated in FIG. 5, is considered to be an equivalent circuit to the actual transformer 51, 52.

The transformer 51, 52 is appropriately designed in order to contribute to the function of the conversion circuit. For example, the transformer 51, 52 may be designed such that a magnetizing inductance of the first winding (i.e. represented by the parallel inductor 53) contributes to a filtering of signals received at the input (e.g. for particular frequencies). Alternatively, the parallel inductor 53 may contribute to an impedance matching of the lamp 3.

The conversion circuit 10 may be further provided with a capacitor arrangement 55. Here the capacitor arrangement 55 is connected in series between the input 11 and the output 12, but the capacitor may otherwise be connected in parallel between the input 11 and the output 12. The capacitor arrangement also contributes to the conversion of the first signals at the input 11 to second signals at the output 12.

FIG. 6 illustrates a cross-section of a suitable transformer 60 for the second embodiment of the conversion circuit. The transformer 60 is adapted to provide a suitably large magnetizing current, so as to contribute to a conversion performed by the conversion circuit 10.

The transformer 60 comprises a first winding 61, and a second winding 62 concentric to one another. The diameter of the first winding 61 is greater than a diameter of the second winding 62, although in other embodiments the diameter of the first winding may be less than the diameter of the second winding.

The windings 61, 62 are arranged around a bobbin 63, which is surrounded by a soft magnetic core 64. The soft magnetic core 64 is also disposed within a gap between two diametrically opposed portions of the bobbin. The first 61 and second 62 concentrically arranged windings are separated by an insulation layer 65.

A distance holder 66 supports the first winding 61 on the bobbin 63. The distance holder increases the creepage distance between first and second windings. Creepage distance is the shortest distance between first and second winding, measured along the surface of the insulation layer. The distance holder may, therefore, improve a safety of the product and ensure that the transformer meets appropriate standards.

An air gap 67 is disposed between the two diametrically opposed parts of the first and second windings. That is, an air gap 67 is formed in the soft magnetic core 64, and spans between diametrically opposite sides of the bobbin 63 and first 61 and second 62 windings.

The transformer 60 provides a stable magnetizing inductance, which does not depend significantly on the amplitudes of the currents flowing in the windings. This is due to the air gap 67 positioned in the center leg of the soft magnetic core 64. The height or size of the air gap defines a magnetizing inductance provided by the transformer 60.

Magnetizing inductance is large for a small air gap 67 and small for a large air gap 67. Thus, it may appear attractive to realize a desired magnetizing inductance using a small air gap and a small number of turns. However, making the air gap smaller is linked to an increase in flux density in the core. It may therefore preferable to limit a minimum size of the air gap in order to avoid saturation of the core or excessive losses in the core.

This transformer 60 thereby provides mains isolation with a well-controlled and precise magnetizing inductance.

In an alternative or further embodiment transformer, rather than or in addition to the air gap 67, control over a magnetizing inductance of a transformer may be effected by using a soft magnetic powder core. A soft magnetic powder core has a relatively small permeability, but its magnetization characteristics are much more linear than those of, for example, sintered ferrites.

Cores with air gaps are usually made from sintered ferrites when operating at frequencies used in fluorescent lamp ballasts. As an alternative or addition to a discrete air gap 67, a core for a transformer (desiring control over magnetizing inductance) may be formed from a soft magnetic material having a small permeability, such as metallic powder cores. Use of such a material may be considered using a “distributed air gap”.

In a similar manner to previously described, if the turns ratio Nₚ/Nₛ is fixed, then the magnetizing inductance will be proportional to the square of the number of turns (i.e. of either first/second winding or the summed number of turns of the first and second windings).

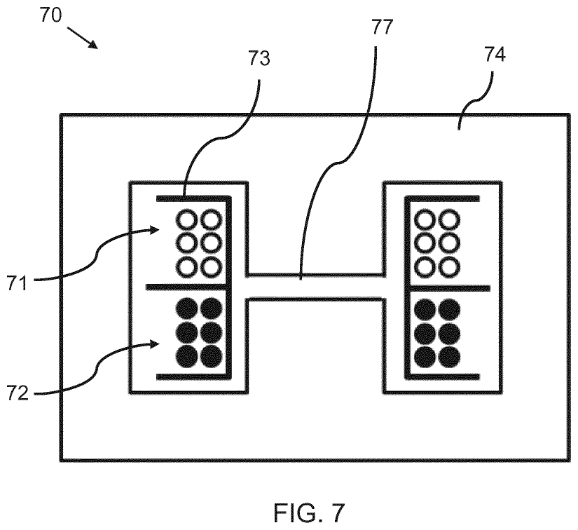

FIG. 7 illustrates a cross-section of another transformer 70 for an embodiment of the conversion circuit, in which both leakage (i.e. series) inductance and magnetizing (i.e. parallel) inductance is desired.

The transformer 70 is similar to the transformer described with reference to FIG. 5. In particular, the transformer comprises first 71 and second 72 windings disposed one above the other around a shared central axis. A soft magnetic core 74 is disposed around and between diametrically opposed sides of the windings/bobbin.

The leakage inductance of the transformer 70 can be controlled by the number of turns of the first and second winding and by the geometry of the windings.

To also enable control over a magnetizing inductance of the transformer 70, an air gap 77 may be provided between diametrically opposed parts of the windings 71, 72. Changing a size and/or height of the air gap 77 changes a magnitude of the magnetizing inductance of the transformer 70.

Generally speaking, to simultaneously act as an inductance and galvanic isolator, energy should be stored in the transformer. The description has presented at least three embodiments for this: (i) introducing an air gap in the soft magnetic core (illustrated in FIGS. 6 and 7) which results in a magnetizing inductance; (ii) increasing the distance between first and second windings in the winding area (illustrated in FIGS. 4 and 7) which results in a leakage inductance and (iii) forming the core from a soft magnetic material having a small permeability, which results in decreased magnetizing inductance. Reducing the permeability of the magnetic core corresponds to increasing the size of a discrete air gap.

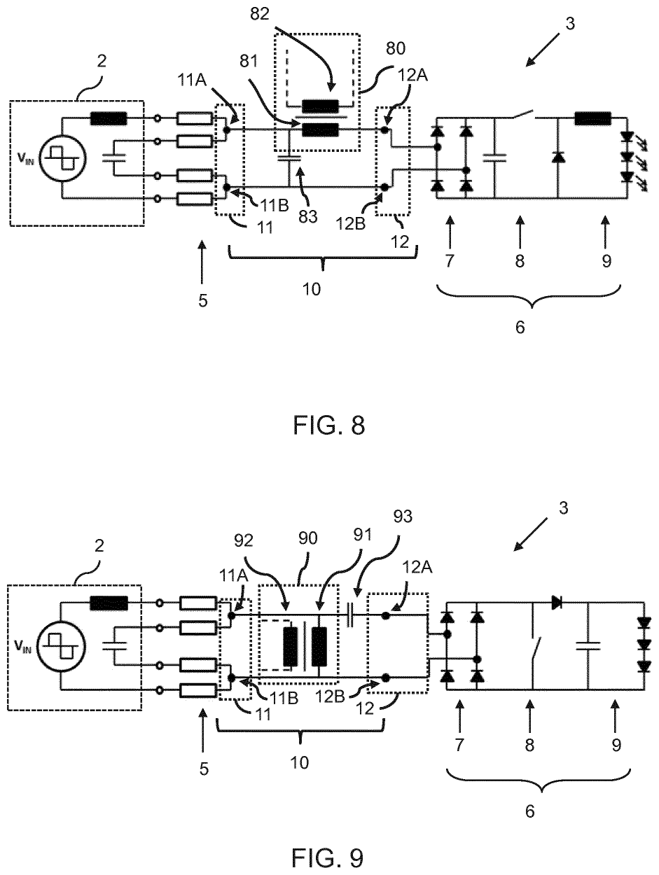

It is noted that leakage inductance is large for a large distance between first and second windings (i.e. as illustrated in FIGS. 4 and 7) and small for a small distance between the first and second windings (as illustrated in FIG. 6). FIG. 8 illustrates a conversion circuit according to a third embodiment of the invention. The conversion circuit 10 is illustrated in the context of a lamp 3, and elements of the lamp identical or similar to previous embodiments will not be described for the sake of brevity.

The conversion circuit 10 provides a second winding 82 magnetically coupled to one of the inductors 81 of a matching circuit (e.g. according to known embodiments). The second winding may thereby draw power for an auxiliary device (e.g. outside the lamp) from the magnetically coupled inductor 81.

Thus, a matching circuit 10 may comprise an inductor arrangement 80 formed of at least one inductor 81 forming a first winding 81. The first winding 81 contributes to the conversion (e.g. filtering, impedance matching) performed by the conversion circuit 10. A second winding 82 is magnetically coupled to the first winding 81. An auxiliary device (not shown) draws power from the second winding, such that the auxiliary device is galvanically isolated from the first winding and thereby from both the lamp 3 and the ballast 2.

The first winding 81 or inductor is connected in series between the input 11 and the output 12 of the conversion circuit 10. In particular, the first winding is connected between a first terminal 11A of the input 11 and a first terminal 12A of the output 12. In other embodiments, the first winding may be connected between the second terminal 11B of the input 11 and the second terminal 12B of the output 12.

As before, the conversion circuit 10 may also comprise a capacitor arrangement 83, comprising at least one capacitor, adapted to contribute to the conversion of first signals to second signals. The capacitor arrangement 83 may be connected in a parallel or series configuration between the input 11 and the output 12 of the conversion circuit 10.

The dashed lines from the second winding 82 indicate a connection from the second winding 82 to the auxiliary device (not shown).

The first winding 81 and second winding 82 may together form a transformer. The transformer may be embodied as any transformer previously described, with particular reference to FIGS. 4, 6 and 7.

For the purposes of conceptual understanding, the first winding 81 and the second winding 82 may be considered to not form an ideal transformer. Rather, the second winding 82 taps a small amount of energy from an inductor formed from the first winding. As such, the second winding 82 only carries current for the auxiliary device.

The second winding 82 is not galvanically connected to the tubular LED arrangement 6, such that the second winding (and thereby the auxiliary device) is galvanically isolated from both the tubular LED arrangement 6 and the ballast 2. In this way, the second winding may be galvanically isolated from the input 11 and the output 12 of the conversion circuit.

This improves an isolation of the auxiliary device, whilst also enabling the tubular LED arrangement to operate at high, potentially electrically unsafe, voltages. This may increase a flexibility and customizability of the auxiliary device and/or tubular LED arrangement.

FIG. 9 illustrates a conversion circuit 10 according to a fourth embodiment of the invention. The fourth embodiment of the invention is a slightly modified version of the third embodiment, described with reference to FIG. 8.

In particular, the inductor arrangement 90 is connected in parallel between the input 11 and the output 12, such that the inductor 91 (forming the first winding) is connected in parallel between the input 11 and the output 12. This provides a parallel inductance.

In particular, the first winding 91 is connected between a first terminal 11A of the input 11 and a second terminal 11B of the input 11, so as to be connected in a parallel arrangement between the input 11 and the output 12. In alternative embodiments, the first winding 91 may be connected between a first terminal 12A of the output 12 and a second terminal 12B of the output 12.

The conversion circuit may also comprise a capacitor arrangement 93 connected between the input 11 and the output 12 of the conversion circuit. The capacitor arrangement 93 is connected in series between the input 11 and the output 12. However, in alternative embodiments, the capacitor arrangement 93 may be connected in parallel between the input and the output.

The conversion circuits 10 illustrated in FIGS. 8 and 9 preferably make use of a magnetizing inductance of the transformer, rather than a leakage inductance. When designing the conversion circuits, the inductor 81, 91 (i.e. the first winding) is designed according to the requirements of the conversion circuit 10, e.g. for filtering or impedance matching requirements. The inductance of this inductor 81, 91 will then be equal to the magnetizing inductance of the transformer.

The second winding 82, 92 is subsequently added having with a small number of turns, preferably using a design as depicted in FIG. 6 in order to minimize the leakage inductance (as this is not required). This forms a transformer 81, 82 or 91, 92.

The major part of the current flowing into the first winding 81, 91 will flow through the magnetizing inductance that acts as an inductor. Only a small fraction of the current will flow via the second (auxiliary) winding to the auxiliary device. The size of this current can be controlled via the input resistance of the auxiliary device.

Thus, the proposed third and fourth embodiments either replaces an existing inductor with a transformer, and exploits the presence of a leakage/magnetizing inductance of the transformer for use in converting signals, or appropriates an existing inductor as a winding of a transformer. In particular, the formed transformer provides an isolated power supply for an auxiliary device. Thus, the auxiliary device and second winding are galvanically isolated from both the ballast 2 and the tubular LED arrangement 6.

Preferably, the auxiliary device is an energy storage device (e.g. comprising a battery or capacitor) forming a reserve power source for the lamp. Such an energy storage device may be charged from the isolated power supply provided by the transformer formed of the first and second windings.

Energy storage by an auxiliary device may be used for purposes such as emergency lighting and grid related electrical energy storage functions like load shifting. Moreover, using energy storage in batteries enables for power correction of the provided power supply (by the ballast). This enables improved compatibility between the ballast and lamp, increased overall efficiency of the lighting installation comprising the ballast and the lamp, as well as improved dimming and standby operation of the lamp.

The energy storage device may discharge power to the lamp, for example, via a bidirectional converter. In some embodiments, the power is discharged via the second winding inducing a current in the first winding. In embodiments, a circuit connected to the second winding (i.e. the auxiliary device) may drive the second winding with an alternating current, thereby inducing a current in the first winding. The first winding may therefore receive power from the second winding.

Embodiments are particularly advantageous when the conversion circuit forms a matching circuit for the lamp. This is because a matching circuit typically requires an inductive impedance to correctly match a required impedance for a ballast. By replacing an inductor with a transformer, as proposed by the present invention, and exploiting the leakage characteristics (e.g. leakage/magnetizing inductance) of the transformer, a dual transformer-inductor may be provided. That is, the transformer acts as both an isolating power supply and an inductor for the matching circuit. This allows an isolated power supply to be provided (e.g. to an auxiliary device) whilst minimizing the space occupied by a transformer.

The matching circuit allows for a lamp to be compatible with a wider range of ballasts, and a minimized size for the lamp allows the lamp to fit into existing troffers or other voids for receiving lamps. Such troffers/voids may have been previously designed for fluorescent tubes, and may therefore have a restricted size and/or weight limit.

In some embodiments, there is proposed a method comprising a step of installing a conversion circuit as previously described between a fluorescent ballast and the tubular LED arrangement.

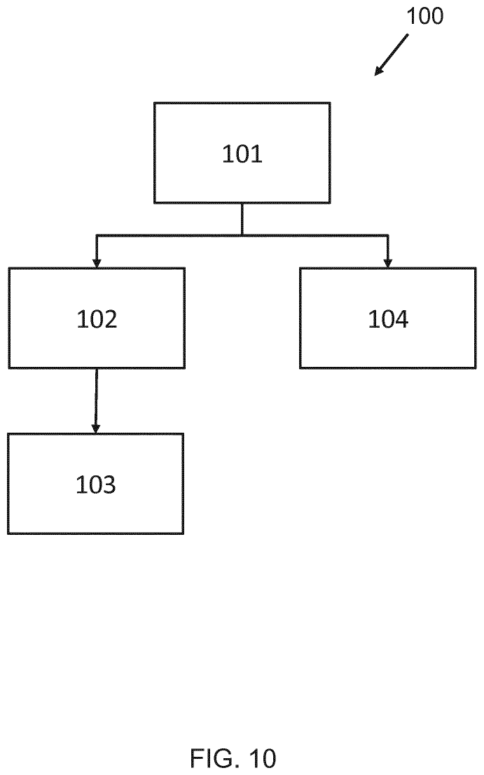

There is also proposed a method 100 for providing a power supply for an auxiliary device of a lamp, as illustrated in FIG. 10. The method 100 is also for converting first signals from a fluorescent ballast to second signals for a tubular LED arrangement of a lamp, the tubular LED arrangement being adapted to output light. The method comprises receiving 101 the first signals, from the fluorescent ballast, at an input. The method also comprises converting 102 the first signals into second signals using at least an inductor arrangement connected between the input and an output, wherein the inductor arrangement is formed of a first winding and a second winding magnetically coupled to the first winding. The method also comprises outputting 103 the second signals, to the tubular LED arrangement, at the output; and providing 104 an isolated power supply for an auxiliary device of the lamp. The first and second windings together form a transformer for providing the isolated power supply and at least one of a leakage inductance or a magnetizing inductance of the transformer contributes to a desired conversion of the first signals to the second signals.

The steps of converting 102 first signals to second signals and outputting 103 the second signals may occur in parallel to the step of providing 104 the isolated power supply. That is, the isolated power supply may be provided to the auxiliary device whilst the conversion circuit is performing a conversion of first signals and provision of second signals. Indeed, it will be apparent from the foregoing that the conversion of the first signals and provision of the second signals may induce the step providing an isolated power supply (as these steps may cause current to flow in the first winding and thereby in the magnetically coupled second winding).

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A conversion circuit for converting first signals from a fluorescent ballast to second signals for a tubular LED arrangement of a lamp, the tubular LED arrangement being adapted to output light, the conversion circuit comprising:
an input for receiving the first signals from the fluorescent ballast;
an output for outputting the second signals to the tubular LED arrangement; and
an inductor arrangement connected between the input and the output, the inductor arrangement formed of a first winding and a second winding, wherein the second winding is magnetically coupled to the first winding and galvanically isolated from both the input and the output,
wherein the first and second windings together form a transformer for providing an isolated power supply for an auxiliary device of the lamp, and wherein at least one of a leakage inductance or a magnetizing inductance of the transformer contributes to a desired conversion of the first signals to the second signals.

2. The conversion circuit of claim 1, wherein the conversion circuit is an impedance matching circuit, and at least one of the leakage inductance and the magnetizing inductance of the transformer contributes to an impedance matching of the impedance matching circuit.

3. The conversion circuit of claim 1, wherein the conversion circuit is a switched-mode power supply, and the first winding forms an energy storage inductor of the switched-mode power supply.

4. The conversion circuit of claim 1 further comprising at least one capacitor arrangement connected between the input and the output.

5. The conversion circuit of claim 1 wherein:
the input comprises a two-terminal input for receiving first signals, the two-terminal input comprising a first input terminal and a second input terminal; and
the output comprises a two-terminal output for supplying the second signals, the two-terminal output comprising a first output terminal and a second output terminal.

6. The conversion circuit of claim 5, wherein the inductor arrangement is connected between any one of:
the first input terminal and the first output terminal;
the second input terminal and the second output terminal;
the first input terminal and the second input terminal; or
the first output terminal and the second output terminal.

7. (canceled)

8. A lamp comprising:
the conversion circuit of claim 1;
a tubular LED arrangement coupled to the output of the conversion circuit.

9. The lamp of claim 8, further comprising an auxiliary device adapted to draw power from the second winding, wherein the auxiliary device is galvanically isolated from the conversion circuit.

10. The lamp of claim 9, wherein the auxiliary device comprises an energy storage device, wherein a power provided by the second winding charges the energy storage device.

11. The lamp of claim 10, wherein the energy storage device is adapted to provide an auxiliary power source to the tubular LED arrangement.

12. The lamp of claim 8, wherein the tubular LED arrangement comprises a rectifier, an LED driver and at least one LED arranged in a string.

13. The lamp of claim 8, further comprising a filament emulation unit for connecting the input of the conversion circuit to the fluorescent ballast.

14. A lighting installation comprising:
a fluorescent ballast; and
a lamp according to claim 9.

15. A method for converting first signals from a fluorescent ballast to second signals for a tubular LED arrangement of a lamp, the tubular LED arrangement being adapted to output light, the method comprising:
receiving the first signals, from the fluorescent ballast, at an input;
converting the first signals into second signals using at least an inductor arrangement connected between the input and an output, wherein the inductor arrangement is formed of a first winding and a second winding magnetically coupled to the first winding;
outputting the second signals, to the tubular LED arrangement, at the output; and
providing an isolated power supply for an auxiliary device of the lamp, wherein the first and second windings together form a transformer for providing the isolated power supply and at least one of a leakage inductance or a magnetizing inductance of the transformer contributes to a desired conversion of the first signals to the second signals, wherein the second winding is magnetically coupled to the first winding and galvanically isolated from both the input and the output.
